(19) United States
(12) Patent Application Publication
(10) Pub. No.: US 2005/0152231 A1
(43) Pub. Date: Jul. 14, 2005

(54) Conversion device of MP3

(76) Inventor: Ming-Hsiang Yeh, Taipei City (TW)

Correspondence Address: TROXELL LAW OFFICE PLLC;SUITE 1404, 5205 LEESBURG PIKE, FALLS CHURCH, VA, 22041, US

(21) Appl. No.: 10/756,280

(22) Filed: Jan. 14, 2004

(51) Int. Cl. H04B 1/20

(52) U.S. Cl. 369/10

(57) ABSTRACT

A conversion device includes a mounting device sized and shaped to fit in a cassette deck of a cassette tape player. The mounting device forms a cutoff zone defined by opposite side edges into which a playing device for compression/decompression, storage and playback of digital sounds is received. Slots are defined in the side edges of the cutoff zone and corresponding projections are formed in opposite sides of the playing device for slidably engaging the slots of the cutoff zone of the mounting device. A signal converter is provided between the playing device and mounting device for receiving MP3 signals from the playing device and converting the MP3 signals into signals recognizable by the cassette tape player.

### FIELD OF THE INVENTION

The present invention generally relates to the field of audio compression and playback, known as MP3, which is an abbreviation of MPEG (Moving Picture Experts Group), Layer 3, and in particular to a device that converts a MP3 player into an internal sound source for a cassette tape player whereby the cassette tape player is capable to play MP3 media.

### BACKGROUND OF THE INVENTION

The development of electronic digital technology brings up a number of digital video/audio devices, such as digital still cameras, VCD/DVD players, CD walkmans and MP3 players. Among these devices, MP3 is of significance due to the internally built sound processing circuit that processes and plays back sounds/music and the large capacity of storage that allows for mass storage of digital data of music or other sounds. In fact, an MP3 player is equivalent, in storage capacity, to the sum of a number of cassette tapes and/or compact discs. Further, the MP 3 gives music with better sound quality than the cassette tape players and compact disc players. Thus, the MP3 player is getting prevailing in the consumer electronics market.

On the other hand, the tape cassette players, although fading out of fashion, still remain in some applications. In addition, most of the consumer cassette tape players that were purchased previous, although hardly used nowadays, are still functioning properly. This becomes a waste of global resources if the cassette tape players cannot be reused.

Thus, the present invention is aimed to make further use of the conventional cassette tape players, which are hardly used nowadays, in order to reduce the waste of global resources.

### SUMMARY OF THE INVENTION

A primary objective of the present invention is to provide a conversion device that allows a cassette tape player to perform MP3 playback and/or recording.

To achieve the above objective, in accordance with the present invention, conversion device comprises a mounting device sized and shaped to fit in a cassette deck of a cassette tape player. The mounting device forms a cutoff zone defined by opposite side edges into which a playing device for compression/decompression, storage and playback of digital sounds is received. Slots are defined in the side edges of the cutoff zone and corresponding projections are formed in opposite sides of the playing device for slidably engaging the slots of the cutoff zone of the mounting device. A signal converter is provided between the playing device and mounting device for receiving MP3 signals from the playing device and converting the MP3 signals into signals recognizable by the cassette tape player.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a conversion device constructed in accordance with the present invention;

FIG. 2 an exploded view of the conversion device of the present invention;

FIG. 3 is a perspective view of the conversion device of the present invention with a playing device partially assembled to a mounting device;

FIG. 4 is a perspective view similar to FIG. 1 but showing an expansion memory card assembled to the conversion device of the present invention;

FIG. 5 is a perspective view showing the playing device is used alone as a regular MP3 player to which an earphone is attached; and

FIG. 6 is an exploded view of a conversion device constructed in accordance with a second embodiment of the present invention.

### DETAILED DESCRIPTION OF THE PREFERRED EMBODIMENTS

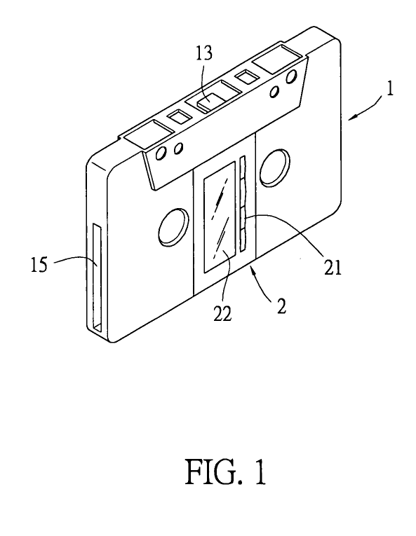

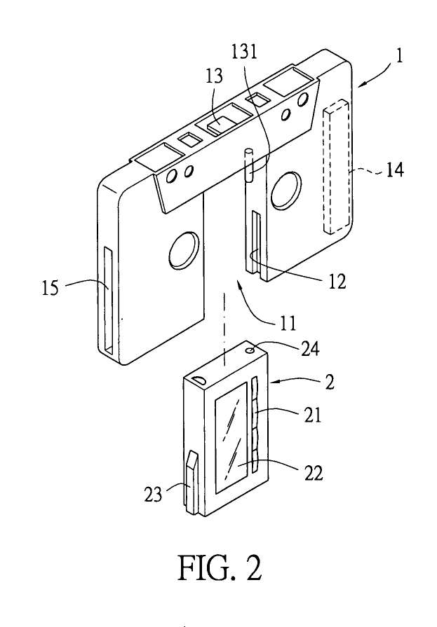

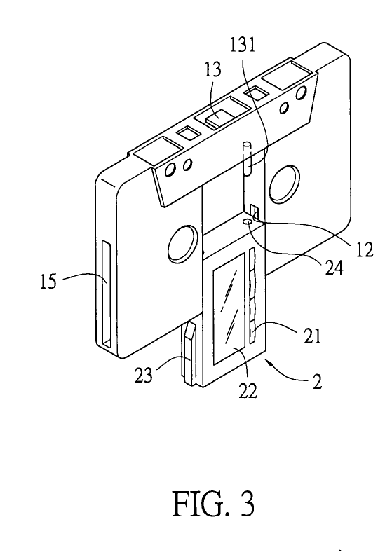

With reference to the drawings and in particular to FIGS. 1-3, a conversion device constructed in accordance with the present invention comprises a mounting device 1 to which a playing device 2 is releasably attached. The conversion device is adapted to fit in a cassette deck of a cassette tape player (not shown) for converting MP3 signals into signals that are recognizable by the cassette tape player. Thus, the mounting device 1, with the playing device 2 attached thereto, is configured as a recording tape cassette receivable in the cassette deck of the cassette tape player (not shown). The outline configuration of a cassette tape is well known and is shown in the drawings and thus no detailed description is necessary.

The mounting device 1 forms a cutoff zone 11 sized to snugly receive the playing device 2 therein. The cutoff zone 11 is defined by two opposite side edges and a closed top edge, and forming a bottom opening for the entrance of the playing device 2. To guide the entrance of the playing device 2 and to secure the playing device 2 in the cutoff zone 11, the side edges of the cutoff zone 11 each form a guide slot 12. The playing device 2, sized and shaped to fit in the cutoff zone 11 of the mounting device 1, has opposite side faces (not labeled) forming projections 23. The projections 23 are slidably receivable in the guide slots 12 of the cutoff zone 11 of the mounting device 1. Alternatively, the side edges of the cutoff zone may form extended ribs, while the playing device 2 forms recesses for slidably receiving the ribs. Similar functions of guiding and securing can also be achieved.

The mounting device 1 comprises a signal converter 13 on a top side thereof, accessible and engageable by a reading/recording head of the cassette tape player (not shown). The signal converter 13 functions to provide electrical signals that are recognizable by the reading/recording head of the cassette tape player. A connector 131 is arranged in or adjacent the cutoff zone 11 of the mounting device 1 and is electrically connected to the signal converter 13. The connector 131 is sized and positioned to engage a mating connector 24 formed in the playing device 2 when the playing device 2 is fit into the cutoff zone 11. For example, the connector 131 may assume the form of a plug, while the mating connector 24 is a socket that receives the insertion of the plug.

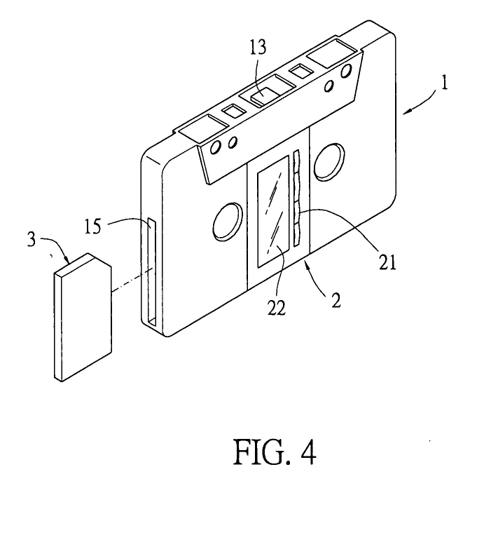

If desired, the conversion device comprises an internal power source 14 that is mounted in the mounting device 1. The power source 14 may comprise any known power source that is fit for the size of the mounting device 1. In addition, a memory card slot 15 is defined in the mounting device 1 for receiving a memory card 3, see FIG. 4, which provides additional storage for sounds/music.

The playing device 2 is in general an MP 3 player made in the form that is suitable to fit in the cutoff zone 11 of the mounting device 1. Thus, the playing device 2, just like a regular MP3 player, is capable to digitally compress/decompress, store and playback of sound/music. To control the operation of the playing device 2, at least one control button 21 is formed on the playing device 2. A display 22 is provided as well. This is similar to the configuration of the regular MP3 player. If desired, the playing device 2 itself may comprise means for receiving and engaging memory cards, micro-optic discs and the likes (not shown).

The playing device 2, after being received into the cutoff zone 11 by means of the guiding engagement between the guide slots 12 of the cutoff zone 11 of the mounting device 1 and the projections 23 of the playing device 2, the playing device 2 is electrically connected to and in signal communication with the signal converter 13 by the engagement between the plug connector 131 of the mounting device 1 and the socket connector 24 of the playing device 2. Thus, the signal generated by the playing back of the playing device 2 is transferred to the signal converter 13 and converted into signals that are recognizable by the cassette tape player, which then plays back the signals through speakers connected thereto.

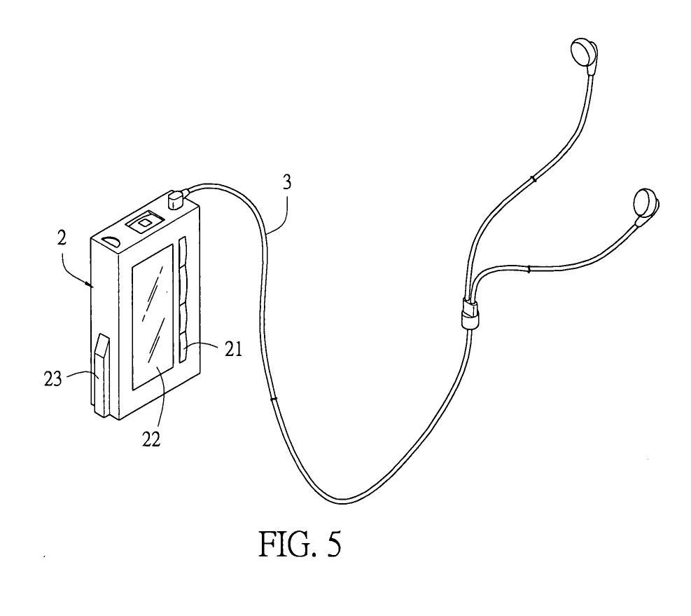

Also referring to FIG. 5, if desired, the playing device 2 may be used alone as a regular MP3 player. In this case, an earphone 3 can be connected to the socket connector 24 of the playing device 2 to convert the signals generated by the playing back of the playing device 2 into audio signals that are recognizable by human ears.

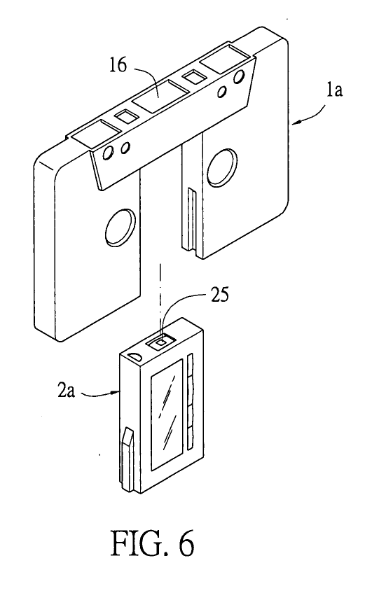

FIG. 6 shows a conversion device constructed in accordance with a second embodiment of the present invention, which comprises a mounting device designated with reference numeral 1a forming a cutoff zone and a playing device 2a sized and shaped to fit into the cutoff zone. The playing device 2a comprises a signal converter 25 formed on a top edge thereof for conversion of the signals generated by the playing back of the playing device 2a into signals that are recognizable by a reading/recording head of a regular cassette tape player (not shown). Corresponding to the signal converter 25, the mounting device la forms an opening 16 in a top edge thereof to expose the signal converter 25 and to allow for engagement of the signal converter 25 by the reading/recording head of the cassette tape player.

Although the present invention has been described with reference to the preferred embodiments thereof, it is apparent to those skilled in the art that a variety of modifications and changes may be made without departing from the scope of the present invention which is intended to be defined by the appended claims.

1. A conversion device comprising:
a mounting device having a configuration of a recording cassette tape, the mounting device forming a cutoff zone defined by opposite side edges, coupling means being formed on the side edges of the cutoff zone;
a playing device sized to fit in the cutoff zone for compression/decompression, storage and playback of digital sound, the playing device having opposite sides on which counterpart coupling means is formed for engaging and thus being guided by the coupling means of the cutoff zone of the mounting device; and
signal conversion means provided between the playing device and mounting device for receiving first signals from the playing device and converting the first signals to second signals adapted to be recognizable by an external playback device.

2. The conversion device as claimed in claim 1, wherein the mounting device comprises an internal power source mounted therein.

3. The conversion device as claimed in claim 1, wherein the mounting device forms a memory card slot for receiving a memory card.

4. The conversion device as claimed in claim 1, wherein the coupling means comprises guide slots defined in the opposite side edges of the cutoff zone, while the counterpart coupling means comprises projections slidable along the guide slots.

5. The conversion device as claimed in claim 1, wherein the coupling means comprises raised ribs, while the counterpart coupling means comprises recesses defined in the playing device for slidably receiving the ribs.

6. The conversion device as claimed in claim 1, wherein the playing device comprises at least one control button and a display.

7. The conversion device as claimed in claim 1, wherein the signal conversion means comprises a converter mounted on the mounting device at a location adapted to be accessed by a reading/recording head of the external playback device and a first connector located in the cutoff zone to engage a second mating connector formed in the playing device.

8. The conversion device as claimed in claim 7, wherein the first connector comprises a plug connector and the second connector comprises a socket engageable by the plug connector.

9. The conversion device as claimed in claim 1, wherein the signal conversion means comprises a converted formed on the playing device and adapted to be accessed by a reading/recording head of the external playback device through an opening defined in the mounting device.

10. The conversion device as claimed in claim 1, wherein the playing device forms a socket adapted to receive and electrically engage an earphone.
